(19) United States
(12) Patent Application Publication
(10) Pub. No.: US 2025/0070393 A1
(43) Pub. Date: Feb. 27, 2025

(54) SEPARATOR FOR LEAD STORAGE BATTERY, AND LEAD STORAGE BATTERY

(71) Applicants: Asahi Kasei Kabushiki Kaisha, Tokyo (JP); Daramic, LLC, Charlotte, NC (US)

(72) Inventors: Hirofumi Goshima, Tokyo (JP); Bo Zhao, Tokyo (JP); Naoto Miyake, Tokyo (JP); Mattanachai Chayangkul, Prachinburi (TH); Jean-Baptiste Lestrade, Prachinburi (TH)

(21) Appl. No.: 18/699,278

(22) PCT Filed: Oct. 18, 2022
(86) PCT No.: PCT/JP2022/038764

§ 371 Date: Nov. 5, 2024

(30) Foreign Application Priority Data
Oct. 19, 2021 (JP) 2021-171154

(51) Int. Cl. H01M 50/463; H01M 10/12

(52) U.S. Cl. CPC H01M 50/463; H01M 10/12

(57) ABSTRACT

[OBJECT] The present invention aims to provide suitable workability of an envelope-shaped separator for a lead-acid battery.

[SOLVING MEANS] Provided is a separator for a flooded lead-acid battery, the separator including a porous base part, side end parts arranged on width direction ends of the porous base part, and a central part interposed by the side end parts, wherein a first rib is arranged in the central part and second ribs are arranged in the side end parts, the first rib has a rib height greater than that of the second ribs, the ratio of the width (U) between both upper end parts to the rib height (H) of a rib width direction cross-section of the second ribs is 0.08 to 5.50 and the ratio of the width(S) between both lower end parts to the rib height (H) thereof is 0.13 to 6.50, the second ribs have radii of curvature (1, 2) at both upper end parts and both lower end parts of the rib width direction cross-section, and the radii of curvature (1, 2) are in the range of 0.005 to 0.350 mm.

### RELATED APPLICATION DATA

The present application claims the benefit of U.S. PCT Application No. PCT/JP2022/038764, filed Oct. 18, 2022, which claims priority to JP Application No. JP 2021-171154, filed Oct. 19, 2021, each of which is incorporated herein by reference in its entirety.

### FIELD

The present invention relates to a technology for providing suitable workability for an envelope-shaped separator.

### BACKGROUND

The main role of a separator is to prevent internal short-circuiting caused by direct contact between the positive and negative electrode plates of a battery. In the case of lead-acid batteries, an envelope-shaped separator is used to enclose an electrode plate, whereby the workability of the envelope-shaped separator is an essential technology and can affect the productivity of the battery.

As a method for forming a separator into an envelope shape, in a common method, a roll of separator is cut into a predetermined length along the length direction thereof, the cut separator is folded in half (i.e., U-shaped), and the edges of both width direction ends of the separator are then sealed with a mechanical seal.

In the process forming a separator into an envelope shape as described above, if the separator cannot travel straight, in some cases, the adhesive portion becomes slanted and the electrode cannot be wrapped neatly, or the adhesive portion is reduced and the separator opens easily. In extreme cases, one end of the separator may not be able to enter the sealing machine in the above process, making it unusable.

### CITATION LIST

### Patent Literature

[PTL 1] Japanese Unexamined Patent Publication (Kokai) No. 2005-108617

### SUMMARY

### Technical Problem

In methods for improving the workability of the envelope-shaped separator, as described in PTL 1, the use or mixing of organic materials which can withstand high pressure or impact during mechanical sealing in place of materials that are inherently inflexible or inelastic, or with materials that are inflexible or inelastic is considered. However, though such a method is effective for the case in which both width direction ends of the separator are partially bonded because opening is inhibited by an improvement in sealing performance even if the bonded portions at both ends of the width direction of the separator are small, it is not suitable for cases in which one end of the separator does not fit into the sealer due to the displacement of the separator.

The present invention was completed based on the above circumstances, and aims to provide suitable workability of an envelope-shaped separator for lead-acid batteries.

### Solution to Problem

The following are examples of technical means for achieving the above object.

(1)

A separator for a flooded lead-acid battery, the separator comprising a porous base part, side end parts arranged on width direction ends of the porous base part, and a central part interposed between the side end parts, wherein:
a first rib is arranged in the central part and second ribs are arranged in the side end parts,
the first rib has a rib height greater than that of the second ribs,
the ratio of the width between both upper end parts to the rib height of a rib width direction cross-section of the second ribs is 0.08 to 5.50 and the ratio of the width between both lower end parts to the rib height of thereof is 0.13 to 6.50,
the second ribs have radii of curvature at both upper end parts and both lower end parts of the rib width direction cross-section, and
the radii of curvature are in the range of 0.005 to 0.350 mm.
   (2)

The separator for a flooded lead-acid battery according to Item 1, wherein the radii of curvature of both upper end parts of the rib width direction cross-section of the second ribs are in the range of 0.01 to 0.20 mm.

(3)

The separator for a flooded lead-acid battery according to Item 1 or 2, wherein the radii of curvature of both lower end parts of the rib width direction cross-section of the second ribs are in the range of 0.01 to 0.30 mm.

(4)

The separator for a flooded lead-acid battery according to any one Items 1 to 3, wherein the ratio of the width between both upper end parts to the rib height of the rib width direction cross-section of the first rib is 0.08 to 1.75 and the ratio of the width between both lower end parts to the rib height thereof is 0.33 to 2.50.

(5)

The separator for a flooded lead-acid battery according to any one of Items 1 to 4, wherein the first rib has radii of curvature at both upper end parts and both lower end parts of the rib width direction cross-section, the radii of curvature of both upper end parts of the rib width direction cross-section of the first rib are in the range of 0.01 to 0.15 mm, and the radii of curvature of both lower end parts thereof are in the range of 0.05 to 0.40 mm.

(6)

A lead-acid battery comprising the separator for a flooded lead-acid battery according to any one of Items 1 to 5.

### Advantageous Effects of Invention

According to the separator for a lead-acid battery disclosed herein, excellent workability can be imparted to the envelope-shaped separator, and, for example, the side seal pass rate of the envelope-shaped separator formation process can be improved.

### BRIEF DESCRIPTION OF DRAWINGS

FIG. 1 is a schematic view showing the shape of a rib in a separator for a flooded lead-acid battery.

### DESCRIPTION OF EMBODIMENTS

### Summary of Present Embodiment

Initially, a summary of the separator for a lead-acid battery (hereinafter referred to as “separator”) according to an embodiment of the present invention (hereinafter referred to as “the present embodiment”) will be described.

The separator for a flooded lead-acid battery disclosed herein comprises a porous base part, side end parts arranged at both width direction ends of the porous base part, and a central part interposed between the side end parts, and is characterized in that a first rib is arranged in the central part and second ribs are arranged in the side end parts, the first rib has a rib height greater than that of the second ribs, the ratio of the width between both upper end parts to the rib height of a rib width direction cross-section of the second ribs is 0.08 to 5.50 and the ratio of the width between both lower end parts to the rib height thereof is 0.13 to 6.50, the second ribs have radii of curvature at both upper end parts and both lower end parts of the rib width direction cross-section, and the radii of curvature are in the range of 0.005 to 0.350 mm.

The present inventors attempted to improve the workability of an envelope-shaped separator by improving the travelability immediately before envelope-shape formation of the separator, and as a result, it was discovered that if the shape of the first rib arranged in the separator central part meets certain conditions, the travelability of the separator tends to be improved to some extent.

However, in the production of an envelope-shaped separator, since both width direction side edges of the separator pass through the envelope-shape forming machine (for example, sealing machine), if only the shape of the first rib is designed, both side end parts do not always enter the sealing machine straight. Thus, the inventors examined the shape design of the second ribs arranged in the side end parts. As a result, according to the present embodiment, it was discovered that suitable travelability can be obtained as a single separator including both side end parts, and that workability can be imparted to the envelope-shaped separator.

Specifically, when the second ribs pass through the sealing machine, if the surface area of the upper parts of the ribs directed toward the sealing machine is small, they will slip and can easily be displaced during contact with the sealing machine, and thus, maximizing the surface area is the essential for imparting workability to the envelope-shaped separator.

Two methods for maximizing the surface area of the upper parts of the ribs of the separator are considered. The first method is to increase the surface area of the upper parts of the ribs, i.e., the area in contact with the sealing machine. In the first method, the upper parts of the ribs of the separator have a certain contact area with the sealing machine to reduce slippage due to friction.

However, even if the contact area with the sealing machine of the upper parts of the ribs of the separator is increased, if the ribs collapse when they enter the sealing machine, the resulting area which can contact is reduced and slippage is likely to occur. Thus, as a second method, it is also important to design a structure which prevents the ribs from collapsing when passing through the sealing machine.

The rib structure according to the present embodiment is constituted by the width between both upper end parts of the rib, the width between both lower end parts of the rib, the rib height, and the radii of curvature of the rib. Furthermore, since vibration which occurs when the rib travels or when the rib contacts an object is related to the parameters described above, by forming in such a manner that the parameters described above are within certain ranges, it is possible to construct a rib shape having a wide surface area and is unlikely to collapse.

Though these two methods can be used independently, the most remarkable effects are seen when they are implemented in combination.

Further, the formability and/or cost of the separator must be considered along with imparting envelope-shaped workability to the separator.

Originally, when forming a separator, oil, which is a plasticizer, is removed from the formed body in the extraction process, but regarding oil in the base part and the rib parts of the separator, it has been found that the amount of oil is greater in the rib parts than in the base part due to the difference in the extrusion speed. This is related to the shape of the rib. For example, it is known that the larger the rib, or the more the rib forms a right angle to the base portion at the upper end portions or the lower end portions of the rib, the more difficult it is for the oil to escape. As a result, the internal resistance of the battery including the separator increases, which is not desirable in forming the separator.

As a feature of the present invention, the inventors have discovered that envelope-shape workability of the separator can be improved by designing the rib shape using the width between both upper end parts of the rib, the width between both lower end parts of the rib, the rib height, and the radii of curvature of the upper and lower end parts of a rib width direction cross-section, which led to the conception and realization of the present invention.

From the foregoing, the inventors were able to impart the separator with envelope-shape workability by designing the parameters related to the rib shape according to the characteristics of the rib shape required when the separator passes through the sealing machine. As a method of forming the rib shape, for example, a molten resin or extruded sheet thereof is passed between a pair of forming rollers with predetermined grooves etched into the rollers, and the ribs are further compressed to a predetermined height. The present invention provides excellent envelope-shape workability.

### Details of the Present Embodiment

The constituent elements of the separator according to the present embodiment is described below with reference to the drawings.

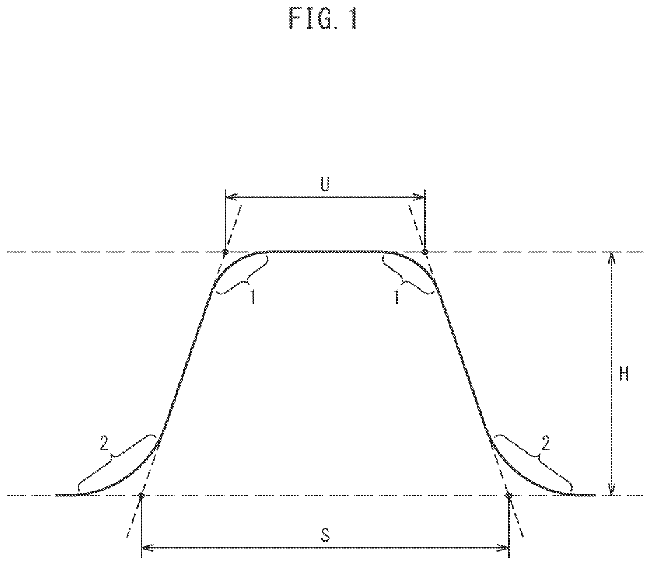

FIG. 1 is a schematic view showing the shape of a rib in a separator for a flooded lead-acid battery according to an embodiment of the present invention. The first and second ribs are not distinguished in FIG. 1, but the first rib as used herein has a rib height (H) greater than that of the second ribs. Further, in addition to the rib height (H), the rib width direction cross-section includes the radius of curvature (1) of both upper end parts, the radius of curvature (2) of both lower end parts, the width between the lower end parts (S), and the width between the upper end parts (U). Regarding the first and second ribs, the radii of curvature (1, 2) of the upper and lower end parts, the rib height (H), the width between both lower end parts (S), and width between both upper end parts (U) can be determined as shown in FIG. 1.

### (Method for Measuring Width (U) Between Both Upper End Parts of Rib Width Direction Cross-Section)

For example, as shown in FIG. 1, in the rib width direction cross-section, there are two intersections between the upper tangent line and the tangent line at the point where the upper outline of the side changes from a straight line to a curve. The distance between the two intersections is measured as (U).

### (Method for Measuring Width (S) Between Both Lower End Parts of Rib Width Direction Cross-Section)

For example, as shown in FIG. 1, in the rib width direction cross-section, there are two intersections between the tangent line at the bottom and the tangent line at the point where the lower outline of the side changes from a straight line to a curve. The distance between these two intersections is measured as (S).

### (Width/Rib Height Ratio of Rib Width Direction Cross-Section)

In the present embodiment, by setting the ratio of the width (U) between both upper end parts to the rib height (H) of a rib width direction cross-section of the second ribs to 0.08 or more and the ratio of the width (S) between both lower end parts to the rib height (H) thereof to 0.13 or more, when the body to be sealed enters the sealing machine, a sufficient contact area with the sealing machine can be secured. Conversely, if the area of the rib width direction cross-section (resulting contact area with the sealing machine) is excessively widened, it becomes difficult to drain the oil present in the rib parts, and the internal resistance of the battery increases. Furthermore, since the cost will increase due to the excessive use of raw materials, it is sufficient that the ratio of the width (U) between both upper end parts to the rib height (H) of a rib width direction cross-section of the ribs be 5.50 or less and the ratio of the width (S) between both lower end parts to the rib height (H) thereof be 6.50 or less.

From this point of view, in the second ribs, it is preferable that the ratio of the width (U) between both upper end parts to the rib height (H) of the rib width direction cross-section be 0.10 or more and 5.00 or less, and the ratio of the width (S) between both lower end parts to the rib height (H) be 0.15 or more and 6.00 or less, it is more preferable that that the ratio of the width (U) between both upper end parts to the rib height (H) be 0.15 or more and 4.50 or less, and the ratio of the width (S) between both lower end parts to the rib height (H) be 0.20 or more and 5.50 or less, it is further preferable that that the ratio of the width (U) between both upper end parts to the rib height (H) be 0.20 or more and 4.00 or less, and the ratio of the width (S) between both lower end parts to the rib height (H) be 0.25 or more and 5.00 or less, and it is most preferable that that the ratio of the width (U) between both upper end parts to the rib height (H) be 0.25 or more and 3.50 or less, and the ratio of the width (S) between both lower end parts to the rib height (H) be 0.30 or more and 4.50 or less.

From the same point of view as above, in the first rib according to the present embodiment, it is preferable that the ratio of the width (U) between both upper end parts to the rib height (H) of the rib width direction cross-section be 0.08 or more and 1.75 or less, and the ratio of the width (S) between both lower end parts to the rib height (H) be 0.33 or more and 2.50 or less, it is more preferable that that the ratio of the width (U) between both upper end parts to the rib height (H) be 0.15 or more and 1.50 or less, and the ratio of the width (S) between both lower end parts to the rib height (H) be 0.43 or more and 2.00 or less, and it is further preferable that that the ratio of the width (U) between both upper end parts to the rib height (H) be 0.20 or more and 1.00 or less, and the ratio of the width (S) between both lower end parts to the rib height (H) be 0.50 or more and 1.50 or less.

### (Relationship Between Width (U) Between Both Upper End Parts and Width (S) Between Both Lower End Parts in Rib Width Direction Cross-Section)

From the viewpoint of a rib shape which has a large surface area and which is unlikely to collapse, it is preferable that the width (S) between both lower end parts be greater than the width (U) between both upper end parts (i.e., (U)<(S)) in the rib width direction cross-section for one or both of the first and second ribs or for the second ribs.

### (Radii of Curvature)

In the present embodiment, by setting the radii of curvature (1, 2) of both upper end parts and both lower end parts of the rib width direction cross-section of the second rib to 0.005 mm or more, in the extraction process in the separator formation process, the oil present in the rib parts can quickly be extracted. Conversely, if the radii of curvature are excessively large, there is a tendency for the ribs to collapse. As a result, slippage occurs upon entry into the sealing machine, and the designed surface area of the upper part of the rib cannot be maintained. It is sufficient that the radii of curvature (1, 2) of both upper end parts and both lower end parts of the rib width direction cross-section of the second rib be 0.350 mm or less.

From this point of view, it is preferable that the radius of curvature (1) of both upper end parts of the rib width direction cross-section of the second rib be 0.01 mm or more and 0.20 mm or less, more preferably 0.03 mm or more and 0.15 mm or less, further preferably 0.04 mm or more and 0.13 mm or less, and most preferably 0.05 mm or more and 0.10 mm or less.

From the same point of view as above, it is preferable that the radius of curvature (2) of both lower end parts of the rib width direction cross-section of the second rib be 0.01 mm or more and 0.30 mm or less, more preferably 0.03 mm or more and 0.25 mm or less, further preferably 0.04 mm or more and 0.20 mm or less, and most preferably 0.05 mm or more and 0.15 mm or less.

Similarly, it is preferable that the radius of curvature (1) of both upper end parts of the rib width direction cross-section of the first rib be 0.01 mm or more and 0.15 mm or less, more preferably 0.02 mm or more and 0.13 mm or less, and further preferably 0.03 mm or more and 0.10 mm or less.

Similarly, it is preferable that the radius of curvature (2) of both lower end parts of the rib width direction cross-section of the first rib be 0.05 mm or more and 0.40 mm or less, more preferably 0.10 mm or more and 0.35 mm or less, and further preferably 0.15 mm or more and 0.20 mm or less.

### (Contained Components)

The separator according to the present embodiment preferably comprises a natural or synthetic material such as a polyolefin resin, phenol resin, polyvinyl chloride (PVC) resin, rubber, synthetic wood pulp (SWP), glass fiber, cellulose material (for example, composed of cellulose or a cellulose derivative and may be in the form of fibers), or a combination thereof. This can result in the formation of a large number communication holes having uniform, fine, and intricate paths throughout the separator. From the viewpoint of the formation of uniform and fine pores throughout the separator, it is more preferable that the separator comprise one or more of polyolefin resins, phenolic resins, polyvinyl chloride resins, rubbers, celluloses, and cellulose derivatives.

### (Method for Production of Separator for Lead-Acid Battery)

An example of a specific method for the production of the separator for a lead-acid battery according to the present embodiment is shown below.

The raw materials, which include a predetermined amount of polyolefin resin, filler, plasticizer, and various additives (such as an antioxidant), are stirred and mixed using a mixer to obtain a raw material mixture. Next, this mixture is heated, melted, and kneaded using a twin-screw extruder, and extruded into a sheet shape. This extruded sheet is then passed between a pair of forming rollers having predetermined grooves engraved on at least one of the rollers to obtain a film-like material having predetermined ribs integrally formed on at least one side of the flat sheet. Next, the film-like material is immersed in an appropriate solvent, and a predetermined amount of the plasticizer is extracted and dried. As a result, the desired microporous film is obtained.

As the polyolefin resin, homopolymers, copolymers, or mixtures of polyethylene, polypropylene, polybutene, and polymethyl pentene can be used. Among these, it is preferable to use mainly polyethylene in terms of formability and economic efficiency. Furthermore, ultra-high molecular weight polyethylene (UHMWPE) is more preferable. Depending on the embodiment, one or more types of ultra-high molecular weight polyethylene are used. Ultra-high molecular weight polyethylene (UHMWPE) has suitable mixing properties with silica, and can be used as a functional material for bonding the framework of silica powder in microporous films, and it is chemically stable and safe.

In the method for obtaining the separator, preferably, a filler and a plasticizer are added to a natural or synthetic material such as the above polyolefin resin, phenolic resin, PVC, rubber, synthetic wood pulp (SWP), glass fibers, cellulose fibers, or combinations thereof, the raw material composition is melt-kneaded, and then some or all of the plasticizer is removed after film formation. As a result, a microporous film having a large number of interconnected pores with uniform, fine, and intricate pathways throughout, which can be used as a separator, can be obtained.

Silica, mica, montmorillonite, kaolinite, asbestos, talc, silicate soil, vermiculite, natural and synthetic zeolites, cement, calcium silicate, clay, aluminum silicate, sodium aluminum silicate, aluminum polysilicate, alumina silica gel, glass particles, carbon black, activated carbon, carbon fiber, charcoal, graphite, titanium oxide, iron oxide, copper oxide, zinc oxide, lead oxide, tungsten, antimony oxide, zirconia, magnesia, alumina, molybdenum disulfide, zinc sulfide, barium sulfate, strontium sulfate, calcium carbonate, magnesium carbonate, and combinations thereof can be used as the filler material. Among these, silica is preferable because it has a wide range of selectable powder characteristics such as particle size and specific surface area, is relatively inexpensive and easy to obtain, and has a low amount of impurities.

As the plasticizer, mineral oil is preferable because it easily reused. The plasticizer is the easiest component to remove from the mixture of polymer, filler, and plasticizer, and thus helps to impart porosity to the separator. The amount of plasticizer in the microporous film separator can be zero, but in separators for flooded lead-acid batteries, an appropriate amount of plasticizer, such as mineral oil, can contribute to improvement of oxidation resistance. In such a case, the content of the plasticizer in the separator is preferably 5 to 30% by weight (wt %). However, if the content of the plasticizer is increased, the porosity of the microporous film decreases and the electrical resistance of the microporous film separator is deteriorated. From this point of view, it is preferable that the content of the plasticizer be 20 wt % or less.

Organic chlorine compounds and saturated hydrocarbon organic solvents such as hexane, heptane, octane, nonane, and decane can be used as the solvent for extracting and removing the plasticizer.

Additives such as surfactants, antioxidants, lubricants, antibacterial agents, and colorants may be added or included in the raw material composition or the microporous film as necessary.

Examples of the surfactant include surfactants such as alkyl sulfate, alkylaryl sulfonate salts, alkylphenol-alkylene oxide addition products, soap, alkylnaphthalene sulfonate, dialkyl esters of sulfosuccinate, quaternary amines, block copolymers of ethylene oxide and propylene oxide, and salts of mono and dialkyl phosphate esters. As the additive, nonionic surfactants such as polyol fatty acid esters, polyethoxylated esters, polyethoxylated fatty alcohols, alkyl polysaccharides such as alkyl polyglycosides and blends thereof, amine ethoxylates, sorbitan fatty acid esters ethoxylates, organosilicone surfactants, ethylene vinyl acetate terpolymers, ethoxylated alkylaryl phosphate esters and sucrose fatty acid esters can be used.

### (Shape and Pore Size of Separator)

The separator has an average pore size of less than 5 μm in diameter, preferably less than 1 μm. Preferably, more than 50% of the pores are less than 0.5 μm in diameter. It is preferable that at least 90% of the pores have a diameter of less than 0.9 μm. In some cases, it is preferable that the separator have an average pore size in the range of 0.01 to 0.3 μm.

Pore size may, in some cases, be determined using the mercury injection method described in Ritter, H. L., and Drake, L. C., Industrial and Technical Chemical Analysis, 17th ed. 787 (1945). According to this method, mercury is injected into pores of different sizes by varying the pressure applied to the mercury using a porosimeter (Porosimeter Model 2000, manufactured by Carlo Erba). Though the pore size is measured by the mercury injection method using a porosimeter, the pore distribution may be determined by evaluating the unanalyzed data in MILESTONE 200 software.

### (Total Thickness)

The total thickness of the separator is preferably greater than 0.1 mm and 5.0 mm or less. The total thickness of the separator can be in the range of 0.15 to 2.5 mm, 0.25 to 2.25 mm, 0.5 to 2.0 mm, 0.5 to 1.5 mm, or 0.75 to 1.5 mm. The total thickness includes not only the base thickness but also the rib height (H), and is measured in the central part where the base thickness and the rib height (H) are the greatest.

### (Base Thickness)

The porous base thickness of the separator is preferably approximately 0.05 mm to approximately 0.500 mm (for example, approximately 0.20 mm or 0.25 mm in certain embodiments).

### (Rib Height)

In the porous base part of the separator, the first rib arranged in the central part has a greater rib height (H) than the second ribs arranged in the side end parts.

The height of the second ribs is preferably greater than 0.1 mm and 0.4 mm or less. As the height of the second ribs increases, the amount of resin adhered by the sealing machine increases, whereby there is a tendency toward sealing difficulty. The height of the first rib is preferably greater than 0.4 mm and 1.2 mm or less. The rib height (H) of the first rib and/or the second ribs is determined in accordance with the use of the battery.

The rib height (H) can be determined in accordance with the design of the forming rollers.

As the rib shape of the separator, at least one surface of the porous base part may be provided with vertical or horizontal continuous or discontinuous linear ribs, serrated ribs, dimple ribs, protrusions, etc., or combinations thereof, as needed. Among these, the plurality of ribs are preferably arranged on at least one side of the porous base part at a height of 0.008 mm to 1 mm and at a distance of 0.001 mm to 20 mm. In one embodiment, the plurality of ribs have a relationship of 0 to 90 degrees (°) between the ribs in a specific surface of the porous base part.

### (Flooded Lead-Acid Battery)

As an embodiment of the flooded lead-acid battery using the separator of the present invention, the following configuration is preferable. The separator is envelope-shaped and accommodates a positive electrode plate or negative electrode plate as required.

As the positive electrode plate, negative electrode plate, electrolyte, lid, and electric tank of the flooded lead-acid battery, any structure known in the art may be used. For example, the separator for flooded lead-acid battery may be incorporated into a vented lead-acid battery in which positive and negative electrode plates is inserted into an electrolyte-filled tank covered with a lid.

A positive electrode rib is provided in the separator housing the positive electrode plate, and depending on the embodiment, a negative electrode rib may be provided in the separator housing the negative electrode plate.

### EXAMPLES

Next, Examples of the present invention will be described in detail along with Comparative Examples. The present invention is not limited to the following examples, and various modifications can be made thereto.

### Example 1

After mixing 30% by weight of a powder of an ultra-high molecular weight polyethylene resin having a weight average molecular weight of 3.5 million as a polyolefin resin, 70% by weight of silica powder, and paraffin mineral oil as a plasticizer with a mixer, 2% by weight of a surfactant by an outside ratio was added, and this raw material composition heated, melted, kneaded, and extruded into a sheet using a twin-screw extruder having a T-die attached to the tip. This extruded sheet was passed between a pair of forming rolls in which one roller was engraved with predetermined grooves for the main ribs for electrode plate contact, and a film-like product was obtained by integrally forming the main electrode plate contact ribs having predetermined shapes on one surface of the flat plate-shaped sheet. Next, this film-like material was immersed in trichlorethylene, a predetermined amount of paraffin-based mineral oil was extracted and removed, and the film-like material was dried to obtain a microporous film having a base thickness of 0.20 mm in the central part. This was used as a separator for a flooded lead-acid battery of Example 1.

### Example 2

A separator was produced in the same manner as in Example 1 except that the forming rollers were different.

### Example 3

A separator was produced in the same manner as in Example 1, except that the forming rollers were different.

### Example 4

A separator was produced in the same manner as in Example 1, except that the forming rollers were different.

### Example 5

A separator was produced in the same manner as in Example 1, except that the forming rollers were different.

### Comparative Example 1

A separator was produced in the same manner as in Example 1, except that the forming rollers were different.

### Comparative Example 2

A separator was produced in the same manner as in Example 1, except that the forming rollers were different.

### Comparative Example 3

A separator was produced in the same manner as in Example 1, except that the forming rollers were different.

### (Incidence of Slant Sealing)

The workability of the envelope-shaped separator is evaluated by the incidence of slant sealing.

Specifically, after carrying out envelope-shaped processing of the separator at a speed of 160 sheets/minute using an envelope machine manufactured by SOVEMA, the distance between the close contact part (seal part) of each of the upper part and lower part of the envelope-shaped separator and the end of the envelope-shaped separator was measured with a ruler. The difference in the distance between the upper part and lower part of 0.5 mm or less was evaluated as no occurrence of slant sealing, and the difference in the distance between the upper part and lower part of 0.6 mm or more was evaluated as occurrence of slant sealing.

1,000 envelope-shaped separators were produced and the incidence of slant sealing was calculated. A value of 0 to 0.50% was evaluated as excellent, 0.51% to 3.00% was evaluated as good, and exceeding 3.00% was evaluated as poor.

Table 1 shows the measurement results of the dimensions and shapes of the separators obtained in Examples 1 to 5 and Comparative Examples 1 to 3, as well as incidence of slant sealing.

TABLE 1

| | | | | | | | Comp | Comp | Comp |
|---|---|---|---|---|---|---|---|---|---|
| Item | Unit | Ex 1 | Ex 2 | Ex 3 | Ex 4 | Ex 5 | Ex 1 | Ex 2 | Ex 3 |
| Width between both | — | 0.30 | 2.05 | 0.50 | 0.67 | 4.00 | 0.07 | 0.83 | 0.83 |
| upper end parts/rib | | | | | | | | | |
| height ratio of second | | | | | | | | | |
| ribs | | | | | | | | | |
| Width between both | — | 0.65 | 2.60 | 1.67 | 2.17 | 5.50 | 0.25 | 2.00 | 2.00 |
| lower end parts/rib | | | | | | | | | |
| height ratio of second | | | | | | | | | |
| ribs | | | | | | | | | |
| Radius of curvature of | mm | 0.050 | 0.050 | 0.220 | 0.050 | 0.220 | 0.500 | 0.380 | 0.380 |
| both upper end parts of | | | | | | | | | |
| rib width direction | | | | | | | | | |
| cross-section of second | | | | | | | | | |
| ribs | | | | | | | | | |
| Radius of curvature of | mm | 0.150 | 0.050 | 0.010 | 0.350 | 0.050 | — | — | — |
| both lower end parts of | | | | | | | | | |
| rib width direction | | | | | | | | | |
| cross-section of second | | | | | | | | | |
| ribs | | | | | | | | | |
| Width between both | — | 0.33 | 0.35 | 0.25 | 0.40 | 1.86 | 0.25 | 0.25 | 0.40 |
| upper end parts/rib | | | | | | | | | |
| height ratio of first rib | | | | | | | | | |
| Width between both | | 0.69 | 0.70 | 0.75 | 0.80 | 2.57 | 0.75 | 0.75 | 0.80 |
| lower end parts/rib | | | | | | | | | |
| height ratio of first rib | | | | | | | | | |
| Radius of curvature of | mm | 0.050 | 0.050 | — | 0.200 | 0.180 | 0.180 | — | 0.200 |
| both upper end parts of | | | | | | | | | |
| rib width direction | | | | | | | | | |
| cross-section of first | | | | | | | | | |
| rib | | | | | | | | | |
| Radius of curvature of | mm | 0.150 | 0.200 | 0.300 | — | — | 0.300 | 0.300 | — |
| both lower end parts of | | | | | | | | | |
| rib width direction | | | | | | | | | |
| cross-section of first | | | | | | | | | |
| rib | | | | | | | | | |
| Incidence of slant | % | Excellent | Excellent | Good | Good | Good | Poor | Poor | Poor |
| sealing | | | | | | | | | |

### INDUSTRIAL APPLICABILITY

The separator for a flooded lead-acid battery according to the present invention is suitable as, for example, a lead-acid battery for automobiles or motorcycles, or idle stop/start (ISS) vehicles. Further, the separator for a flooded lead-acid battery according to the present invention can also be suitably used as a power storage device for electric vehicles such as forklifts.

### REFERENCE SIGNS LIST

1 radius of curvature of both upper end parts
2 radius of curvature of both lower end parts
H rib height
S width between both lower end parts of rib width direction cross-section
U width between both upper end parts of rib width direction cross-section

1. A separator for a flooded lead-acid battery, the separator comprising a porous base part, side end parts arranged on width direction ends of the porous base part, and a central part interposed between the side end parts, wherein:
a first rib is arranged in the central part and second ribs are arranged in the side end parts,
the first rib has a rib height greater than that of the second ribs,
the ratio of the width between both upper end parts to the rib height of a rib width direction cross-section of the second ribs is 0.08 to 5.50 and the ratio of the width between both lower end parts to the rib height thereof is 0.13 to 6.50,
the second ribs have radii of curvature at both upper end parts and both lower end parts of the rib width direction cross-section, and
the radii of curvature are in the range of 0.005 to 0.350 mm.

2. The separator for a flooded lead-acid battery according to claim 1, wherein the radii of curvature of both upper end parts of the rib width direction cross-section of the second ribs are in the range of 0.01 to 0.20 mm.

3. The separator for a flooded lead-acid battery according to claim 1, wherein the radii of curvature of both lower end parts of the rib width direction cross-section of the second ribs are in the range of 0.01 to 0.30 mm.

4. The separator for a flooded lead-acid battery according to claim 1, wherein the ratio of the width between both upper end parts to the rib height of the rib width direction cross-section of the first rib is 0.08 to 1.75 and the ratio of the width between both lower end parts to the rib height thereof is 0.33 to 2.50.

5. The separator for a flooded lead-acid battery according to claim 1, wherein the first rib has radii of curvature at both upper end parts and both lower end parts of the rib width direction cross-section, the radii of curvature of both upper end parts of the rib width direction cross-section of the first rib are in the range of 0.01 to 0.15 mm, and the radii of curvature of both lower end parts thereof are in the range of 0.05 to 0.40 mm.

6. A lead-acid battery comprising the separator for a flooded lead-acid battery according to claim 1.
